(19) United States
(12) Patent Application Publication
(10) Pub. No.: US 2015/0126650 A1
(43) Pub. Date: May 7, 2015

(54) ANTIMONY-FREE FLAME-RETARDED STYRENIC THERMOPLASTIC POLYMER COMPOSITION, ARTICLE CONTAINING SAME AND METHOD OF MAKING SAME

(71) Applicant: ICL-IP AMERICA INC., Ardsley, NY (US)

(72) Inventors: Pierre Georlette, Omer (IL); Eyal Eden, Shoham (IL); Rachel Shtekler, Moshav (IL); Marc Leifer, Gedera (IL); Sergei V. Levchik, Croton-on-Hudson, NY (US)

(21) Appl. No.: 14/400,118

(22) PCT Filed: May 3, 2013
(86) PCT No.: PCT/US2013/039474

§ 371 Date: Nov. 10, 2014

Related U.S. Application Data
(60) Provisional application No. 61/651,244, filed on May 24, 2012.

(51) Int. Cl. C08L 25/06

(52) U.S. Cl. CPC C08L 25/06; C08L 2201/02; C08L 2201/08; C08L 2203/20
USPC 524/101

(57) ABSTRACT

There is provided herein an antimony trioxide-free flame-retarded styrenic thermoplastic polymer composition comprising: (a) at least one styrenic thermoplastic polymer; (b) at least one brominated flame retardant, (c) at least one metal phosphonate; and, (d) at least one antidripping agent. There is also provided a method of making said flame retarded styrenic thermoplastic polymer composition; and, an article comprising the styrenic thermoplastic polymer composition.

The present application claims priority to U.S. Provisional Application No. 61/651,244 filed May 24, 2012 which is herein incorporated by reference in its entirety.

### FIELD OF THE INVENTION

The present invention relates to flame-retarded thermoplastic compositions and more particularly to flame-retarded styrenic thermoplastic polymer compositions and articles containing the same.

### BACKGROUND OF THE INVENTION

Styrenic polymers and more specifically high impact polystyrene (HIPS) and acrylonitrile, butadiene, styrene polymers (ABS) plastics are used for the production of electronic parts such as housings, cases and internal parts, amongst others. In most of these applications, flame retardancy is needed and is usually provided by flame retardant systems based on a combination of brominated flame retardants with antimony trioxide as a synergist. But this type of flame retardant system has limitations, because antimony trioxide, being a very efficient synergist, tends to significantly increase smoke yield, which impairs visibility which could create problems for evacuation of people in the case of a fire. Further, antimony trioxide has a very high bulk density which increases the specific gravity of molded parts containing the same. This is especially undesirable in transportation and aviation applications. Furthermore, antimony trioxide has significantly increased in price in recent years. Still further, some recently introduced ecolabels require elimination of antimony trioxide from thermoplastic parts.

Although there is a clear need for low antimony trioxide or antimony trioxide-free flame retardant plastics, such plastics usually requires a significant increase in the loading of brominated flame retardant which is also undesirable.

### SUMMARY OF THE INVENTION

It has been unexpectedly discovered by the inventors herein that a combination of brominated flame retardant, a high phosphorus-content flame retardant and an antidripping agent provides an excellent flame retardant additive composition for use in styrenic thermoplastic polymers, more specifically HIPS and ABS thermoplastics, such flame-retardant additive compositions provide flame retardant efficiency adequate to styrenic thermoplastic resins in electrical and electronic applications without the use of antimony trioxide.

The present invention is directed to an antimony trioxide-free flame-retarded styrenic thermoplastic polymer composition comprising:
(a) at least one styrenic thermoplastic polymer;
(b) at least one brominated flame retardant;
(c) at least one metal phosphonate; and,
(d) at least one antidripping agent, more specifically, polytetrafluoroethylene (PTFE)

Further, the flame-retarded styrenic thermoplastic polymer composition can optionally further comprise impact modifiers, heat stabilizers, antioxidants, processing aids, and other additives enhancing physical properties of the resin.

Further, the present invention is also directed to a molded article comprising a styrenic thermoplastic polymer, a brominated flame retardant, aluminum methyl methylphosphonate, PTFE, and optionally one or more of an antioxidant, processing aid, and colorant.

Still further, the present invention is directed to a method of making a flame-retarded article comprising blending a thermoplastic polymer, a brominated flame retardant, a metal phosphonate, e.g., aluminum methyl methylphosphonate and an antidripping agent, e.g., PTFE.

It will be understood herein that any reference to a flame-retarded styrenic thermoplastic polymer composition is such that the composition is in the absence of antimony trioxide.

### DETAILED DESCRIPTION OF THE INVENTION

The present invention is directed to a flame retardant additive composition that comprises a unique and unexpected combination of a bromine compound, a high phosphorus-content compound and an antidripping agent, e.g., polytetrafluoroethylene. Such flame retardant additive compositions can be used in styrenic thermoplastic polymers and compositions containing styrenic thermoplastic polymers, to provide flame retardancy without use of antimony trioxide.

Styrenic thermoplastic polymer (a), as used herein, refers to polymers, and specifically copolymers (including terpolymers), which contain (optionally substituted) a styrenic structural unit, however combined with one or more other structural units. More specific examples of styrenic thermoplastic polymer (a) are styrene-based copolymers belonging to the following classes:

1. HIPS: rubber-modified copolymers of styrenic monomers, obtainable, for example, by mixing an elastomer (butadiene) with the (optionally substituted) styrenic monomer(s) prior to polymerization. The styrenic thermoplastic polymer (a) generally comprise between 40 wt % and 85 wt %, more specifically between 50 wt % and 85 wt % HIPS resins having a melt flow index (MFI) between 1 and 50 g/10 min (measured according to ISO 1133; 200° C./5 kg).

2. ABS: copolymers and terpolymers that include the structural units corresponding to (optionally substituted) styrene, acrylonitrile and butadiene, regardless of the composition and method of production of said polymers. The styrenic thermoplastic polymer (a) can comprise between 40 wt % and 85 wt %, more specifically between 50 wt % and 83 wt % ABS having an MFI between 1 and 50 g/10 min (measured according to ISO 1133 at 220° C./10 kg).

3. SAN: copolymer of acrylonitrile and styrene, and SMA; copolymer of styrene with maleic anhydride. The styrenic thermoplastic polymer (a) can in one embodiment comprise between 40 wt % and 85 wt % SAN, and in another embodiment can comprise between 40 wt % and 85 wt % SMA.

In one embodiment the flame-retarded styrenic thermoplastic polymer composition of the invention can contain as the styrenic thermoplastic polymer (a) an alloy of styrene-containing polymers, namely, a blend of a styrene-containing polymer as set forth above with a second polymer or copolymer (such blends are obtained by extruding pellets of the styrene-containing polymer (a) and pellets of the second polymer in desired proportions). Some non-limiting examples of such blends include a blend of HIPS and polyphenylene oxide or a blend of ABS with polycarbonate. For an ABS/polycarbonate alloy, such can comprise the styrene-containing polymer (ABS) at a concentration in the range between 5 wt % and 85 wt %.

In one embodiment thermoplastic styrenic polymer (a) is different from brominated flame retardant (b). In one embodiment the thermoplastic styrenic polymer (a) is non-halogenated.

Brominated flame retardant (b) includes any flame retardant which contains a bromine atom in its chemical structure. The most specific brominated flame retardant compounds (b) have the following formulae.

Decabromodiphenyl oxide sold under the trade name FR-1210

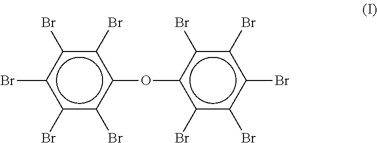

Tetrabromobisphenol A sold under the trade name FR-1524

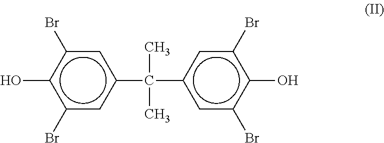

Tetrabromobisphenol A bis(2,3-dibromopropyl ether) sold under the trade name FR-720

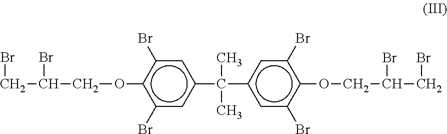

Tris(tribromophcnoxy)triazine sold under the trade name FR-245

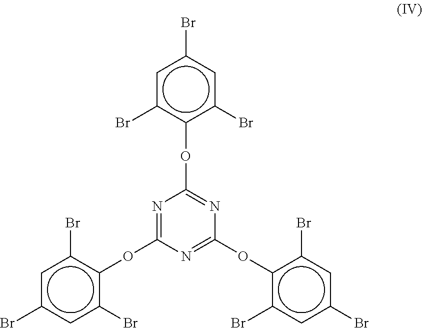

Tris(tribromoneopenyl) phosphate sold under the trade name FR-370

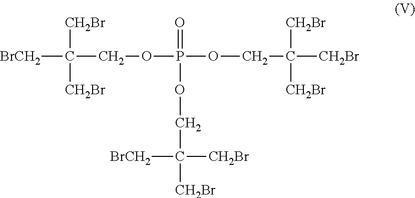

Brominated polyacrylate sold under the trade name FR-1025

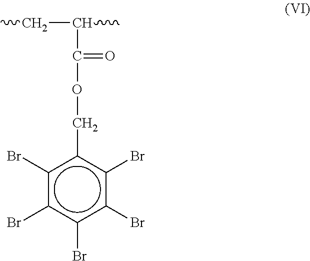

Brominated polystyrene sold under the trade name FR-803P

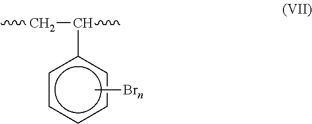

Brominated epoxy polymers sold under the trade name F-2000 series

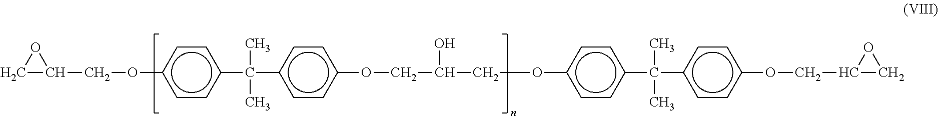

Brominated end-capped epoxy polymers sold under the trade name F-3000 series

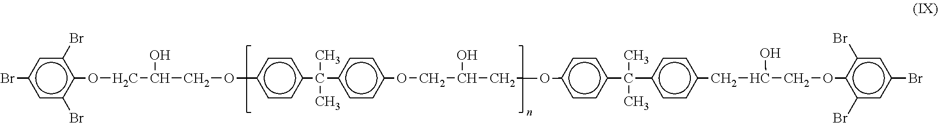

Phenoxy-terminated carbonate oligomer of tetrabromnobisphenol A

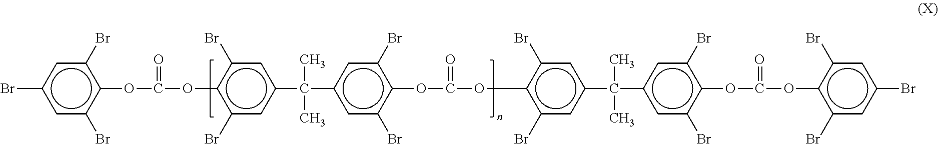

Decabromodiphenylethane

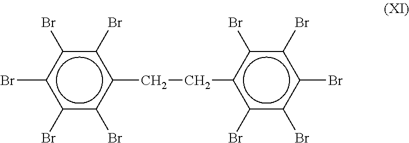

Tetradecabromodiphenoxybenzene

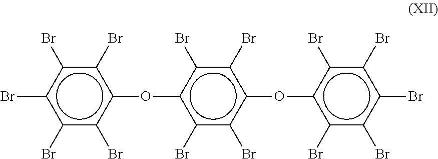

Ethylenebistetrabromophthalimide

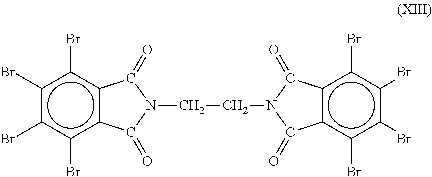

Tetrabromobisphenol S bis(2,3-dibromopropyl ether)

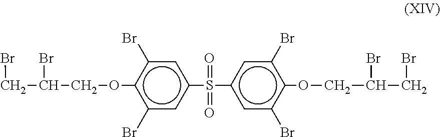

Poly-dibromophenylene oxide

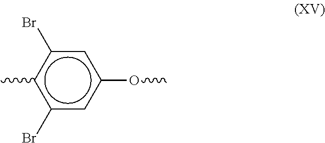

2-ethylhexyl tetrabromophthalate ester

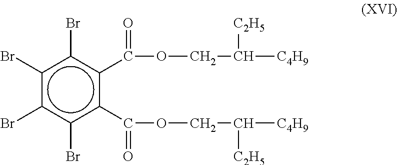

Bis(tribromophenoxy) ethane

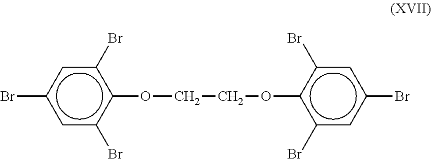

Preferably, the brominated flame retardant (b) is present in the flame-retarded styrenic thermoplastic polymer composition in the range of from about 5 wt % to about 40 wt % and specifically in the range from about 5 wt % to about 30 wt % based on the total weight of the flame-retarded styrenic thermoplastic polymer composition.

The metal phosphonate (c) used herein can be a salt of alkyl alkylphosphonic acid or a salt of aryl alkylphosphonic acid. In one embodiment the salt of alkyl alkylphosphonic acid or salt of aryl alkylphosphonic acid can be such that the alkyl group and/or aryl group contains up to about 12 carbon atoms. In a further embodiment the metal phosphonate (c) is represented by general formula (I):

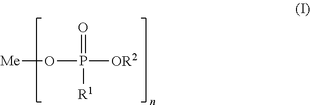

where Me is a metal, n is equal to the valency of the metal which is in the range of from 1 to 4, specifically 2 or 3, R¹ is a linear or branched alkyl of up to about 12 carbon atoms, specifically from 1 to about 4 carbon atoms, R² is a linear or branched alkyl of up to about 12 carbon atoms, specifically from 1 to about 4 carbon atoms or a substituted aryl or an unsubstituted aryl of general formula (II):

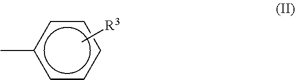

where R³ is hydrogen, or a branched or linear alkyl of up to about 4 carbon atoms, or NH₂ or CN or NO₂.

In one specific embodiment, R¹ and/or R² are each independently methyl or ethyl radicals.

Metals, i.e., Me of the above formula (I), include alkaline earth or transition metals such as the non-limiting group consisting of Ca, Mg, Zn, Al, Fe, Ni, Cr, Ti. The most specific metal is Al.

In one embodiment the metal phosphonate (c) of the formula (I) is an aluminum salt of methyl methylphosphonic acid (AMMP), where Me is aluminum, R¹ and R² are both methyl and n=3. AMMP contains a high level (i.e., 26 weight percent) of active phosphorus. AMMP can be synthesized either by reacting methyl methylphosphonate with an aqueous solution of sodium hydroxide followed by precipitation with aluminum chloride, or by direct reaction of aluminum hydroxide with methyl methylphosphonate at about 180° C. in high shear mixer.

Specifically, the metal phosphonate (c) is a powder with an average particle size of less than about 25 microns, specifically less than about 10 microns, and even more specifically less than about 5 microns. The most specific metal phosphonate (c) average particle size according to the present embodiments comprises an average size in the range of from about 0.1 microns to about 3 microns. It will be understood that any of the aforementioned average particle size ranges can have a lower end point of from about 0.1 microns.

Specifically, the metal phosphonate (c) is present in the flame-retarded styrenic thermoplastic polymer composition in the range from about 1 wt % to about 15 wt % and more specifically in the range from about 2 wt % to about 10 wt % based on the total weight of the flame-retarded styrenic thermoplastic polymer composition.

Antidripping agent (d) is generally a fluoropolymer or copolymer containing a fluoro-ethylenic structure. Examples of the antidripping agent include difluoroethylene polymers, tetrafluoroethylene polymers, tetrafluoroethylene-hexafluoropropylene copolymers, and copolymers of tetrafluoroethylene with fluorine-free ethylenic monomers. More specifically the antidripping agent (d) is polytetrafluoroethylene (PTFE). Any and every type of polytetrafluoroethylene known at present in the art is usable for antidripping agent (d).

Among polytetrafluoroethylenes, the use of those which are capable of forming fibrils can impart especially high melt-dripping preventing ability. The fibril-forming polytetrafluoroethylene used herein is not specifically limited. Specific examples of the polytetrafluoroethylene capable of forming fibrils include Teflon 6C (registered trademark of DuPont) or Hostaflon 2071 (registered trademark of Dynon).

The content of the antidripping agent (d) the flame-retarded styrenic thermoplastic polymer composition is generally from 0.05 percent by weight to 2 percent by weight, specifically between 0.1 percent by weight to 0.5 percent by weight. The amount of the fluororesin may be suitably determined depending on the required flame retardancy of the article formed from the flame-retarded styrenic thermoplastic polymer composition, for example, based on V-0, V-1 or V-2 in UL-94 in consideration with the amount of the other components.

The antimony trioxide-free flame retarded styrenic thermoplastic polymer composition may also further comprise impact modifiers such as elastomers and core-shell polymers. These elastomers can be thermoplastic elastomers, which can be melt-mixed with thermoplastic styrenic resin (a) because they are solids having rubber-like elasticity at normal temperature, but heating them decreases the viscosity thereof. The specific thermoplastic elastomer used is not particularly restricted, and olefin-, styrene-, polyester-, polyamide- and urethane-based elastomers may be used as non-limiting examples.

Other ingredients that can be employed in amounts less than 10 percent by weight of the antimony trioxide-free flame retarded styrenic thermoplastic polymer composition, specifically less than 5 percent by weight, include the non-limiting examples of lubricants, heat stabilizers, light stabilizers and other additives used to enhance the properties of the resin. Such other ingredients may be specifically utilized in amounts from 0.01 to 5 percent by weight of the total weight of the antimony trioxide-free flame-retarded styrenic thermoplastic polymer composition and include specific examples such as hindered phenols and phosphites.

In one embodiment herein, the antimony trioxide-free flame retarded styrenic thermoplastic polymer composition comprises styrenic thermoplastic polymer (a), e.g., HIPS, ABS, SAN or SMA resin in an amount of from about 40 wt % to about 85 wt %; brominated flame retardant (b) in an amount of from about 5 wt % to about 40 wt %; metal phosphonate (c) in an amount of from about 1 wt % to about 15 wt % and antidripping agent (d), e.g., PTFE in an amount of from about 0.05 wt % to about 2 wt % all based on the total weight of the antimony trioxide-free flame retarded styrenic thermoplastic polymer composition.

In a more specific embodiment, the antimony trioxide-free flame-retarded styrenic thermoplastic polymer composition comprises styrenic thermoplastic polymer (a), e.g., HIPS, ABS, SAN or SMA resin in an amount of from about 50 wt % to about 85 wt %; brominated flame retardant (b) in an amount of from about 5 wt % to about 30 wt %; the metal phosphonate (c) in an amount of from about 2 wt % to about 10 wt % weight percent and antidripping agent(d), e.g., PTFE in an amount of from about 0.1 wt % to about 0.5 wt % all based on the total weight of the antimony trioxide-free flame retarded styrenic thermoplastic polymer composition.

These amounts of flame retardant additives (b), (c) and (d) in the antimony trioxide-free flame-retarded styrenic thermoplastic polymer composition or articles made therefrom are flame-retardant effective amounts thereof.

The antimony trioxide-free flame-retarded styrenic thermoplastic polymer composition or articles made therefrom herein can have a flame retardancy classification of one or more of HB, V-2, V-1, V-0 and 5VA according to UL-94 protocol. In one embodiment, the antimony trioxide-free flame retarded styrenic thermoplastic polymer composition can have a flame retardancy of at least V-1 or V-0.

There is also provided herein a method of making a flame-retarded article comprising blending the flame-retarded styrenic thermoplastic polymer compositions of this invention, the manner of which is not critical, and can be carried out by conventional techniques. One convenient method comprises blending the styrenic polymer (a) and other ingredients in powder or granular form, extruding the blend and comminuting the blend into pellets or other suitable shapes.

Although it is not essential, the best results are obtained if the ingredients (a), (b), (c) and (d) are precompounded, pelletized and then molded into a desirable article. Precompounding can be carried out in conventional equipment. For example, the styrenic polymer (a), other ingredients (b), (c) and (d), and, optionally, other additives are fed into a twin screw extruder in the form of a dry blend of the composition, the screw employed having a long transition section to insure proper melting. In one specific embodiment, a twin screw extrusion machine e.g., a ZE25 with L/D=32 ex Berstorff extruder can be fed with the styrenic resins and additives at the feed port. In either case, a generally suitable machine temperature will be about 180° to 250° C.

The antimony trioxide-free flame-retarded styrenic thermoplastic polymer composition can be molded in any equipment conventionally used for thermoplastic compositions. For example, good results will be obtained in an injection molding machine, e.g. of the Arburg 320S Allrounder 500-150 type, at conventional temperatures, e.g., 200 to 270 C. If necessary, depending on the molding properties of the styrenic polymer (a), the amount of additives, resin flow and the rate of solidification of the styrenic polymer (a), those skilled in the art will be able to make the conventional adjustments in molding cycles to accommodate the composition.

In another embodiment herein there is provided a molded article comprising antimony trioxide-free flame-retarded styrenic thermoplastic polymer composition, specifically where the molded article is made by injection molding the contents of the blended flame-retarded styrenic thermoplastic polymer composition.

The antimony trioxide-free flame-retarded styrenic thermoplastic polymer composition of the present invention is useful, for example, in the production of electronic components, such as for example, housings and frames and the like.

In a specific embodiment herein there are provided injection molded components, e.g., electronic components, comprising a styrenic polymer (a), and a flame retardant additive composition, which flame retardant additive composition comprises brominated flame retardant (b), e.g., tribromophenol triazine, metal phosphonate (c), e.g., aluminum methyl methylphosphonate and antidripping agent (d), e.g., PTFE.

In another embodiment there is provided a flame retarded article, e.g., an electronic component, preferably an injection molded electronic component, as described herein, made by the above-described method.

The following examples are used to illustrate the present invention.

### Examples

In order to prepare samples of flame-retarded HIPS and ABS that illustrate the invention, the following procedures have been used.

### 1. Materials.

The materials used in this study are presented in Table 1.

### 2. Compounding

The polymers pellets, AMMP, PTFE and stabilizers were weighted on semi analytical scales with consequent manual mixing in plastic bags. The mixtures were introduced into the main feeding port of the extruder via feeder No. 1. FR-245 introduced into the main feeding port of the extruder via feeder No. 2.

The compounding was performed in a twin screw co-rotating I/D=32 ex Berstorff ZE25 at 180°-220° C.

The obtained pellets of compounded mixtures were dried in a circulating air oven ex Heraeus instruments at 120° C. for 4 hours.

### 3. Injection Molding.

Test specimens were prepared by injection molding the pellets of compounded mixtures in Allrounder 500-150 ex. Arburg at 200-220 C.

### 4. Conditioning

Specimens were conditioned at 23° C. for 168 hours before testing.

5. Flammability test

Flammability was tested on 1.6 mm standard bars according to UL-94 vertical ignition protocol.

### 6. Results

Composition and tests results for HIPS and ABS are presented in Table 2. As it is shown in comparative example 3 the formulation without PTFE required 11 wt. % Br and 4.4 wt. % Sb₂O₃ to pass V-0 rating. The addition of 0.1 wt. % PTFE (comparative example 4) allowed a decrease of Sb₂O₃, content to 1 wt. % with only a modest increase in Br content to 15 wt. %. However, complete elimination of Sb₂O₃ (Comparative Example 5) required 20 wt. % Br in order to pass V-0. In contrast, the use of a formulation containing 16 wt. % Br and 1.3 wt. % phosphorus coming from aluminum phosphonate (examples 1 and 2) resulted in a V-1 rating in HIPS. A V-1 rating is required for most electronic equipment applications. This formulation was antimony trioxide-free and had a relatively low Br content.

A very similar trend was observed with the use of ABS polymer. 21 wt. % Br was required to pass a V-0 rating in an antimony trioxide-free formulation (comparative example 10), but only 16 wt. % Br and 1.3 wt. % phosphorus was needed for an antimony-free formulation containing aluminum methyl phosphonate.

TABLE 1
Materials

| TRADE NAME | | |
|---|---|---|
| (PRODUCER) | GENERAL INFO | FUNCTION |
| HIPS Styron 1200 ex Dow | High Impact Polystyrene | Plastic matrix |
| ABS Magnum 3404 ex Dow | Acrylonitrile butadiene | Plastic matrix |
| | styrene terpolymer, | |
| | general purpose grade | |
| FR-245 ex. ICL-IP America | Tristribromophe- | Flame retardant |
| | nylisocyanurate | |
| AMMP | Aluminum MethylMethyl | Flame retardant |
| | Phosphonate (26% P) | |
| PTFE Hostaflon 2071 ex | PTFE fine powder (500μ) | Anti-dripping |
| Dynon | | agent |
| Irganox B225 ex Ciba | Blend of Irganox 1010 | Heat stabilizer/ |
| | (hindered phenol type) | antioxidant |
| | and Irgafos 168 | |
| | (phosphite type) | |

TABLE 2
Flammability performance and physical properties of flame retardant HIPS and ABS

| | | HIPS | | | | | ABS | | | | |
|---|---|---|---|---|---|---|---|---|---|---|---|
| | Units | | | Comp. | Comp. | Comp. | | | Comp. | Comp. | Comp. |
| | Weight % | Ex. 1 | Ex. 2 | Ex. 3 | Ex. 4 | Ex. 5 | Ex. 6 | Ex. 7 | Ex. 8 | Ex. 9 | Ex. 10 |
| Polymer | wt. % | 70.7 | 70.8 | 77.9 | 76 | 69.6 | 70.7 | 70.8 | 79.6 | 76.1 | 68.2 |
| FR-245 | wt. % | 23.9 | 23.9 | 16.4 | 22.4 | 30 | 23.9 | 23.9 | 14.9 | 22.4 | 31.4 |
| AMMP | wt. % | 5 | 5 | | | | 5 | 5 | | | |
| AO-112 | | | | 5.5 | 1.3 | | | | 5 | 1.3 | |
| PTFE | wt. % | 0.2 | 0.1 | | 0.1 | 0.2 | 0.2 | 0.1 | | 0.1 | 0.2 |
| Irganox B-225 | wt. % | 0.2 | 0.2 | 0.2 | 0.2 | 0.2 | 0.2 | 0.2 | 0.2 | 0.2 | 0.2 |
| Bromine | wt. % | 16 | 16 | 11 | 15 | 20 | 16 | 16 | 10 | 15 | 21 |
| P content | wt. % | 1.3 | 1.3 | | | | 1.3 | 1.3 | | | |
| Sb₂O₃ content | | | | 4.4 | 1 | | | | 4 | 1 | |
| UL-94 rating | | V-1 | V-1 | V-0 | V-0 | V-0 | V-0 | V-0 | V-0 | V-0 | V-0 |

While the above description comprises many specifics, these specifics should not be construed as limitations, but merely as exemplifications of specific embodiments thereof. Those skilled in the art will envision many other embodiments within the scope and spirit of the description as defined by the claims appended herein.

1. An antimony trioxide-free flame-retarded styrenic thermoplastic polymer composition comprising:
(a) at least one styrenic thermoplastic polymer;
(b) at least one brominated flame retardant;
(c) at least one metal phosphonate; and,
(d) at least one antidripping agent.

2. The flame-retarded styrenic thermoplastic polymer composition of claim 1, wherein styrenic thermoplastic polymer (a) is at least one selected from the group consisting of high impact polystyrene (HIPS), acrylonitrile-butadiene-styrene copolymer (ABS), styrene-acrylonitrile copolymer (SAN), styrene-maleic anhydride copolymer (SMA).

3. The flame-retarded styrenic thermoplastic polymer composition of claim 1, wherein brominated flame retardant (b) is at least one compound selected from the group consisting of decabromodiphenyl oxide, tetrabromobisphenol A, tetrabromobisphenol A bis(2,3-dibromopropyl ether), tris(tribromophenoxy)triazine, tris(tribromoneopenyl) phosphate, brominated polyacrylate, brominated polystyrene, brominated epoxy polymers, brominated end-capped epoxy polymers, phenoxy-terminated carbonate oligomer of tetrabromobisphenol A, decabromodiphenylethane, tetradecabromodiphenoxybenzene, ethylenebistetrabromophthalimide, tetrabromobisphenol S bis(2,3-dibromopropyl ether), poly-dibromophenylene oxide, 2-ethylhexyl tetrabromophthalate ester and bis (tribromophenoxy) ethane.

4. The flame-regarded styrenic thermoplastic polymer composition of claim 1, wherein the metal phosphonate (c) is a salt of alkyl alkylphosphonic acid or aryl alkylphosphonic acid, wherein each alkyl and/or aryl contains up to 12 carbon atoms.

5. The flame-retarded styrenic thermoplastic polymer composition of claim 4, wherein the salt of alkyl phosphonic acid or aryl alkyl phosphonic acid is represented by general formula (I): 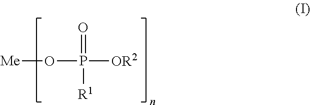
wherein Me is a metal, n is equal to the valency of the metal and is an integer of from 1 to 4, R¹ is a linear or branched alkyl of up to about 12 carbon atoms, R² is a linear or branched alkyl of up to about 12 carbon atoms or a substituted aryl or an unsubstituted aryl of general formula (II): 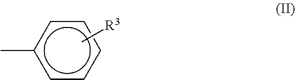
where R³ is selected from hydrogen, a branched or linear alkyl of up to about 4 carbon atoms, NH₂, CN and NO₂.

6. The flame-retarded styrenic thermoplastic polymer composition of claim 5, wherein n is 2 or 3, and/or wherein R¹ is a linear or branched alkyl of up to 4 carbon atoms.

7. The flame-retarded styrenic thermoplastic polymer composition of claim 4, wherein the metal phosphonate (c) is aluminum methyl methylphosphonate.

8. The flame-retarded styrenic thermoplastic polymer composition of claim 1, wherein the antidripping agent (d) is polytetrafluoroethylene.

9. The flame-retarded styrenic thermoplastic polymer composition of claim 1 further comprising an impact modifier.

10. The flame-retarded styrenic thermoplastic polymer composition of claim 1 further comprising a heat stabilizer and/or an antioxidant.

11. The flame-retarded styrenic thermoplastic polymer composition of claim 1 wherein the styrenic polymer (a) is present in an amount of from about 40 to about 85 weight percent; the brominated flame retardant (b) is present in an amount of from about 5 to about 40 weight percent, the metal phosphonate (c) is present in an amount from about 1 to about 15 weight percent and the antidripping agent (d) is present in the amount from 0.01 to 2 weight percent wherein said weight percents are based on the total weight of the flame-retarded styrenic thermoplastic polymer composition.

12. The flame-retarded styrenic thermoplastic polymer composition of claim 1 wherein the styrenic polymer (a) is present in an amount of from about 50 to about 85 weight percent; the brominated flame retardant (b) is present in an amount of from about 5 to about 30 weight percent, the metal phosphonate (c) is present in an amount from about 2 to about 10 weight percent and the antidripping agent (d) is present in the amount from 0.1 to 0.5 weight percent wherein said weight percents are based on the total weight of the flame-retarded styrenic thermoplastic polymer composition.

13. A molded article comprising the flame-retarded styrenic thermoplastic polymer composition of claim 1.

14. A method of making a flame-retarded article comprising blending
(a) at least one thermoplastic styrenic polymer;
(b) at least one brominated flame retardant,
(c) at least one metal phosphonate
(d) at least one antidripping agent; and,
optionally at least one of an impact modifier, antioxidant, heat stabilizer and light stabilizer, wherein blending occurs in the absence of antimony tri-oxide.

15. A flame-retarded article made by the method of claim 14.

16. The flame-retarded article of claim 15 wherein the article is an injection-molded electric component.
